(19) United States
(12) Patent Application Publication
(10) Pub. No.: US 2022/0383036 A1
(43) Pub. Date: Dec. 1, 2022

(54) CLUSTERING DATA USING NEURAL NETWORKS BASED ON NORMALIZED CUTS

(71) Applicant: Google LLC, Mountain View, CA (US)

(72) Inventors: Azade Nazi, San Jose, CA (US); Azalia Mirhoseini, San Jose, CA (US); Anna Darling Goldie, Mountain View, CA (US); Sujith Ravi, Santa Clara, CA (US); William Hang, Stanford, CA (US)

(21) Appl. No.: 17/764,015

(22) PCT Filed: Sep. 25, 2020
(86) PCT No.: PCT/US2020/052813

§ 371 Date: Mar. 25, 2022

Related U.S. Application Data
(60) Provisional application No. 62/906,081, filed on Sep. 25, 2019.

(51) Int. Cl. G06K 9/62; G06N 3/08

(52) U.S. Cl. CPC G06K 9/6224; G06K 9/6215; G06K 9/6259; G06N 3/08

(57) ABSTRACT

Methods, systems, and apparatus, including computer programs encoded on computer storage media, for training a clustering neural network. One of the methods includes obtaining unlabeled training data; and training the clustering neural network on the unlabeled training data to determine trained values of the clustering parameters by minimizing a normalized cuts loss function that includes a first term that measures an expected normalized cuts of clustering nodes in a graph representing the data set into the plurality of clusters according to clustering outputs generated by the clustering neural network.

### BACKGROUND

This specification relates to training a neural network to cluster data.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that trains a clustering neural network in an unsupervised manner. The training is referred to as unsupervised because no data identifying a ground truth or target clustering assignment that should be generated by the clustering neural network is used during the training. One the clustering neural network has been trained on a data set, the clustering neural network can be used to generate a final clustering of the items in the data set, i.e., by selecting, for each item in the data set, the argmax cluster in the probability distribution over clusters. The clustering neural network can also be used to cluster other items in other data sets in the same manner without retraining the clustering neural network. That is, the trained clustering neural network can generalize to other data sets.

The data set can be a data set that has explicit relationships between items in the data set, i.e., input data representing a graph with nodes representing items and edges representing relationships between items. Examples of such data sets include computational graphs, graphs with nodes representing computer chip design components, graphs with nodes representing social network connections, and knowledge graphs with nodes representing entities and edges representing relationships between entities.

The data set can also be a data set that has implicit relationships between items in the data set, i.e., relationships that can be determined based on a similarity between items in the data set. That is, these are data sets that are not graphs but that can be represented as a graph, e.g., images, text documents, videos, and so on, where relationships or “affinity weights” between inputs measure similarity between items.

Particular embodiments of the subject matter described in this specification can be implemented so as to realize one or more of the following advantages.

The system can train the clustering neural network in an unsupervised fashion. The training improves the suitability of the final clustering for downstream tasks, e.g., device placement for computational graphs, placement of computer chip components, classification for implicit graphs, and so on. By training the clustering neural network using an end-to-end learning approach with a differentiable loss that directly minimizes the normalized cuts, the described techniques produce lower normalized cuts values than existing techniques, which consequently results in better clustering accuracy and in better generalizability to unseen input data. Moreover, unlike many existing techniques for unsupervised deep learning, the trained clustering neural network directly outputs final cluster assignments rather than embeddings that need further processing to be usable. Thus, the described techniques allow for a data set to be clustered accurately and with reduced consumption of computational resources (e.g., processor cycles) relative to conventional techniques.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example clustering system.

FIG. 1B shows how the example clustering system can be used for integrated circuit design.

FIG. 2 illustrates how the clustering system trains the CNC model.

FIG. 3 is a flow diagram of an example process for training the clustering neural network.

FIG. 4 is a flow diagram of another example process for training the clustering neural network.

Like reference numbers and designations in the various drawings indicate like elements.

### DETAILED DESCRIPTION

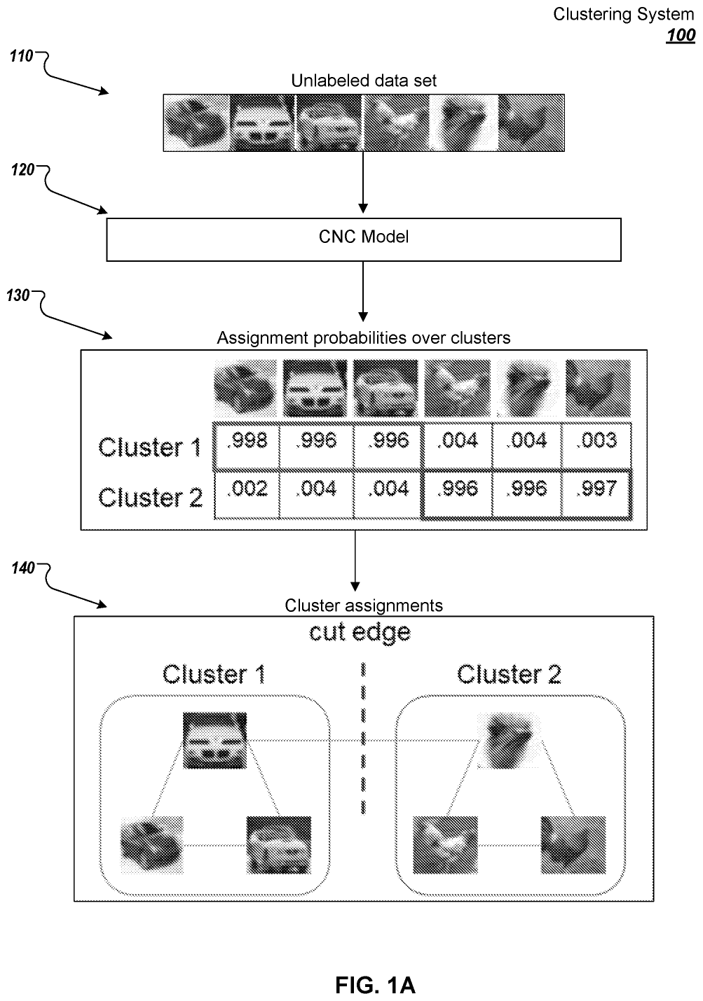

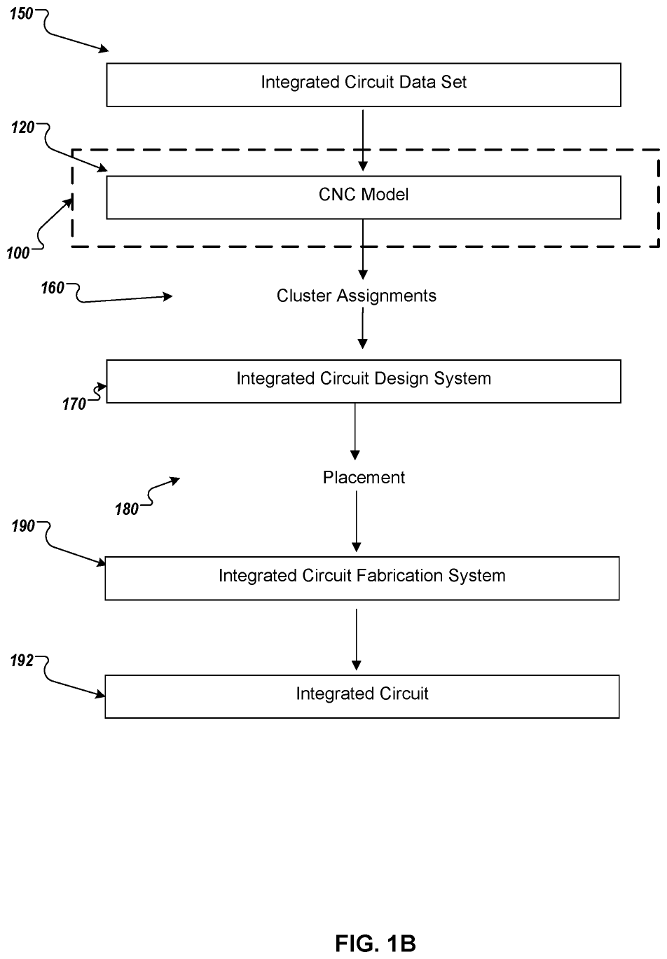

FIG. 1A shows an example clustering system 100. The clustering system 100 is an example of a system implemented as computer programs on one or more computers in one or more locations, in which the systems, components, and techniques described below can be implemented.

The system 100 receives an unlabeled data set 110 and generates cluster assignments 140 for each item in the data set. Cluster assignments group the items in the data set into a desired number of clusters so that items in the same cluster are more similar to each other than to those in other clusters. The task in the example of FIG. 1 is to cluster the unlabeled data set 110 into two clusters.

The data set 110 can be a data set that has explicit relationships between items in the data set, e.g., can be data this represented as a graph having nodes and edges. In particular, each node in the graph represents an item in the data set and each edge connects two nodes in the graph and represents a relationship between the items represented by the two nodes.

Examples of graphs include computational graphs with nodes representing operations and edges representing data dependencies between the operations, graphs with nodes representing computer chip design components, e.g., nodes on a netlist of nodes that represents the electronic components on a computer chip, and edges representing connections between the components, graphs with nodes representing entities on a social network and edges representing social network connections between the entities, knowledge graphs with nodes representing entities and edges representing relationships between entities, and so on.

Alternatively, the data set can be a data set that has implicit relationships between items in the data set. In other words, the data set may not explicitly define relationships between the items, but the system 100 or another system can determine relationships between the entities based on a similarity between items in the data set. These are data sets that are not graphs but can be represented as graphs, such as sets of images or videos (collectively referred to as “visual data”), or text documents. In these cases, the relationship between two items in the data set can be based on, e.g., a semantic or visual similarity between the two items. In the example of FIG. 1A, the unlabeled data set 110 is a set of images.

The unlabeled data set 110 is given as input to the CNC Model 120. As will be described in more detail below, the model is referred to as a “CNC” model because it is trained using a framework for Clustering by learning to optimize expected Normalized Cuts.

In the input to the CNC model 120, the data set can be represented as data representing a graph, where nodes in the graph represent items in the data set and edges represent relationships between those items. Each edge can have a different edge weight depending on the relationship between the nodes it is connected to.

The CNC Model 120 processes the input to generate as output assignment probabilities over clusters 130. That, the CNC model 120 assigns, to each item in the data set, a respective probability of belonging to each of the desired number of clusters. The assignment probabilities 130 are distributions that represent the likelihood that each item in the data set belongs in the corresponding cluster.

In the example of FIG. 1A, the car images have higher probabilities of being in Cluster 1, and lower probabilities of being in Cluster 2. The bird images have higher probabilities of being in Cluster 2, and lower probabilities of being in Cluster 1.

The system 100 uses the assignment probabilities 130 to generate cluster assignments 140. For example, the system 100 can assign each data item to the cluster that has the highest probability according to the assignment probabilities 130. The items are thus assigned to clusters based on similarity between items.

As described above, the CNC Model 120 is trained by minimizing the expected normalized cuts of the cluster assignments 140. Generally, normalized cuts calculates the cost (in term of edge weights) of cutting, or removing, edges to form disjoint sets in the graph.

In the example of FIG. 1A, the graph shows that there are edges among the car images and edges among the bird images. There is also an edge between one of the car images and one of the bird images. The example shows that cutting this edge resulted in the minimum normalized cuts, i.e., as compared to any other possible clustering assignment. By cutting this edge and removing the relationship between the car image and bird image, two disjoint clusters are formed. The car images are thus assigned to Cluster 1 and the bird images are assigned to Cluster 2.

In some implementations, after the CNC Model 120 has been trained, the system 100 can receive a new data set 110 and generate new cluster assignments 140 without re-training the CNC Model 120. That is, because of the way the CNC model 120 has been trained, the model 120 can generalize to effectively clustering new data sets 110 without needing to be re-trained on the new data sets.

Once the system 100 has generated the final cluster assignments 140 for a given data set, in some implementations the system 100 or another system then uses the cluster assignments 140 to perform a downstream task on the data set. Some non-exhaustive examples of downstream tasks follow.

As one example, when the data set is a computational graph, the system 100 can use the cluster assignments to distribute the execution of the computational graph across a plurality of devices, e.g., by assigning all of the items (operations) in each cluster to the same device. The plurality of devices can then execute the computational graph in accordance with the assignments, with each device executing the operations that have been assigned to the device. This can allow for a more efficient execution of the operations by the plurality of devices by adapting the execution of the operations based on a combination of hardware considerations and the results of the clustering.

As another example, when the data set is a set of electronic components for an integrated circuit, the system 100 can use the cluster assignments to generate a design the integrated circuit, i.e., to place different electronic components on different locations on the surface of the integrated circuit. For example, the system can place all of the items (electronic components) in each cluster in the same region of the on the surface of the integrated circuit. This can improve the performance of the designed integrated circuit, e.g., decrease the latency or increase the throughput of computation due to more efficient wiring or improve the spatial efficiency of the circuit.

As another example, when the data set is content items, e.g., images, videos, or text documents, the system 100 can use the cluster assignments 140 to perform a downstream machine learning task on the content items. For example, the system can perform a classification task on the data items using the cluster assignments 140, e.g., by classifying all of the items in the same cluster to the same category from a set of categories for the classification task. In this way, the accuracy of the classification of data can improved.

FIG. 1B shows how the example clustering system 100 can be used for integrated circuit design.

In the example of FIG. 1B, the system 100 receives an integrated circuit data set 150 that includes a plurality of electronic components that are to be included in an integrated circuit and generates cluster assignments 160 for each electronic component in the data set using the CNC model 120 as described above with reference to FIG. 1A. That is, the system 100 assigns each electronic component into a respective one of a fixed number of clusters.

An integrated circuit design system 170 then places the electronic components at respective locations on the surface of the integrated circuit using the cluster assignments 160 to generate a placement 180. For example, the integrated circuit design system 170 can place each cluster of electronic components in the same grid cell of a grid over the surface of the integrated circuit components. Example techniques for placing clusters of electronic components are described in Mirhoseini, et al, Chip Placement with Deep Reinforcement Learning, arxiv:2004.10746.

An integrated circuit fabrication system 190 can then fabricate an integrated circuit 192 that includes the electronic components placed at the locations specified by the placement 180.

As described, by using the CNC model 120, the resulting integrated circuit 192 can exhibit improved performance or spatial efficiency, e.g., relative to other techniques that would place components using different kinds of clustering techniques.

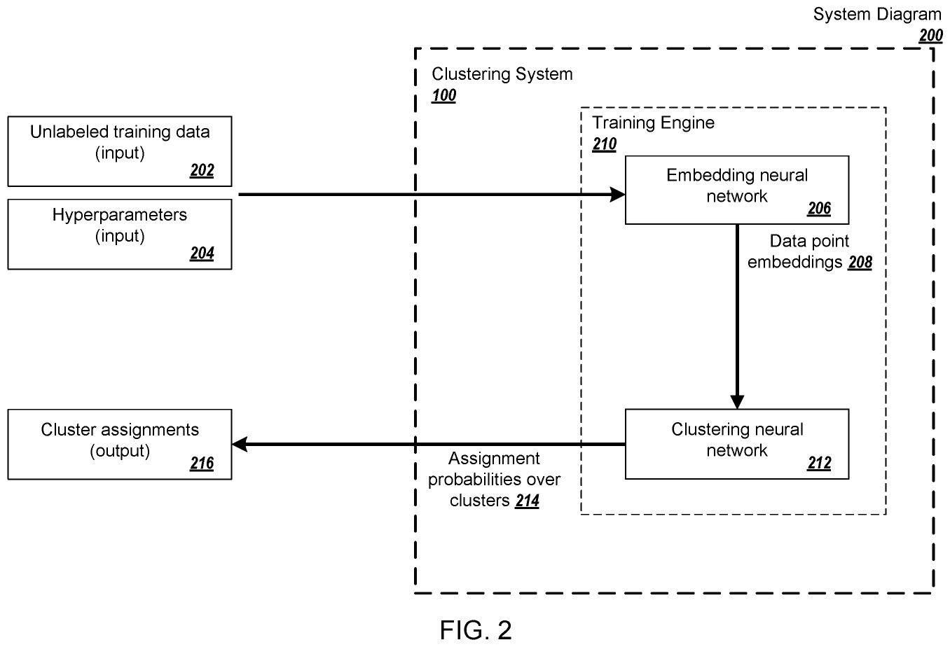

FIG. 2 is a diagram that illustrates how the clustering system 100 trains a CNC model to cluster unlabeled training data 202.

As shown in FIG. 2, the CNC model includes a clustering neural network 212 and, optionally, an embedding neural network 206.

The embedding neural network 206 is a neural network that receives an input data set of items and processes the input data set to generate respective feature embeddings of each of the items.

The embedding neural network 206 can have any appropriate architecture that allows the neural network 206 to map a set of data items, i.e., map the data items or features of the data items, to a respective feature embedding for each data item that has a fixed dimensionality. For example, the embedding neural network 206 can be a convolutional or fully-connected neural network.

The system 100 or another system trains the embedding neural network 206 to generate feature embeddings that represent affinities between items in the data set. For example, the embedding neural network 206 can be trained as a Siamese neural network, i.e., to learn an adaptive nearest neighbor metric.

The clustering neural network 212 is a neural network having parameters (“clustering parameters”) and that is configured to receive input data that includes respective feature embeddings of each of a plurality of items and to process the input data in accordance with the clustering parameters to generate, for each item in the plurality of items, a respective clustering output that defines a probability distribution that includes a respective probability for each of a plurality of clusters. The number of clusters is generally set to a fixed number prior to training.

The clustering neural network 212 can have any appropriate architecture that allows the neural network 212 to map a set of feature embeddings to a respective probability distribution for each feature embedding. For example, the clustering neural network 212 can include one or more fully-connected layers followed by an output layer, e.g., a softmax or a gumble softmax, that produces the probability distributions.

To train the clustering neural network 212, the clustering system 100 receives unlabeled training data 202. The unlabeled training data 202 generally includes items from one or more data sets of items. The training data 202 is referred to as “unlabeled” because the system does not receive or does not make use of any data (“labels”) that indicate how the system 100 should cluster any of the data sets. In other words, the system does not use any external information that specifies which clusters the items in the data sets should be assigned to.

After training the neural network 112, the clustering system 100 outputs cluster assignments 216 according to the values given by the trained values of the clustering parameters, i.e., cluster assignments 216 that cluster the unlabeled training data 202 into the desired number of clusters.

Within the clustering system 100, a training engine 210 performs the training of the clustering neural network 212.

In some implementations, e.g., when another system has trained the embedding neural network or when the system 100 operates on already generated feature embeddings, the system 100 does not include the embedding neural network 206 and receives feature embeddings as an input.

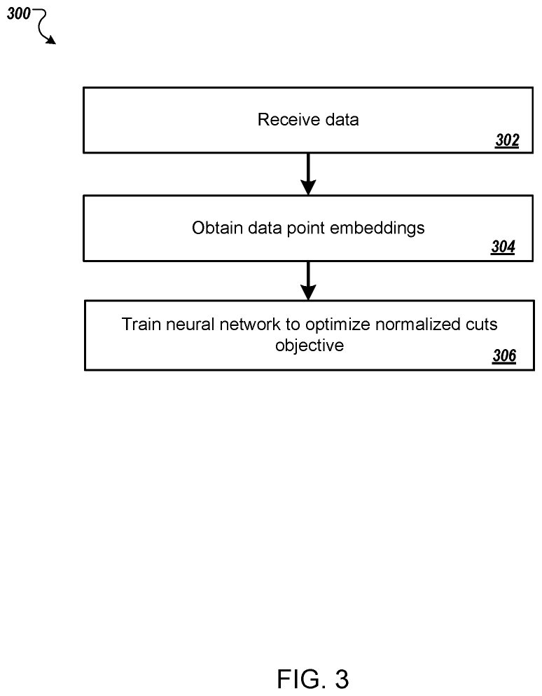

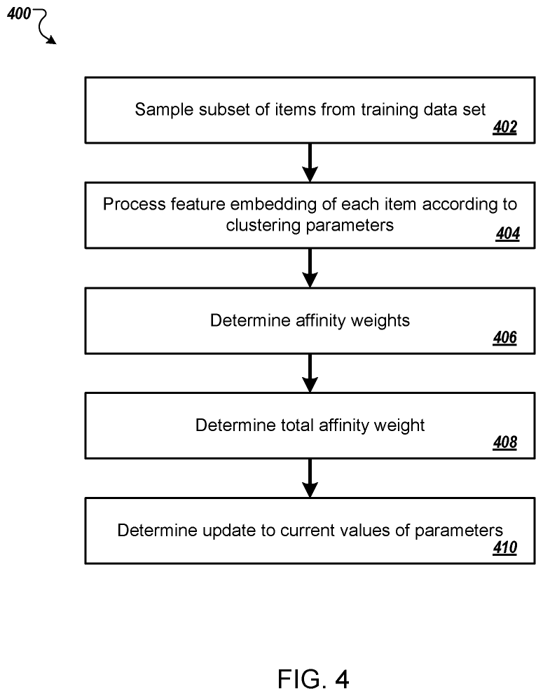

The operation of the training engine 210 and optional embedding neural network will be described in more detail below with reference to FIG. 3. The training of the clustering neural network 212 will be described in more detail below with reference to FIG. 4. Generally, however, the goal of the training is to minimize a normalized cuts loss function.

The training engine 210 trains the clustering neural network 212 to generate clustering assignments that minimize the normalized cuts loss function, i.e., to determine trained values of the clustering parameters of the clustering neural network 212. For example, these trained values can be ones that result in the loss function converging, or the values after the clustering neural network 212 has been trained for a set amount of time or for a set number of training steps.

The training engine 210 then outputs the final assignment probabilities over clusters 214 by processing the embeddings 208 of the unlabeled training data 202 using the trained clustering neural network 212.

In other words, the clustering system 100 uses the assignment probabilities that were generated by the clustering neural network 212 in accordance with the trained values of the clustering parameters to output the cluster assignments 216 for each item, i.e., by assigning each item to the cluster that it has the highest probability of belonging to according to the final assignment probabilities for the item.

FIG. 3 is a flow diagram of an example process 300 for training the neural network. For example, a clustering system, e.g., the clustering system 100 of FIG. 2, appropriately performed in accordance with this specification, can perform the process 300.

The system receives training data (step 302). As described above, the training data is an unlabeled data set of items.

The system obtains data point embeddings (also referred to as “feature embeddings”) (step 304). Generally, these embeddings capture the affinities of the data points in the data set. The affinity is a measure of the distance between items in the data set. For example, different affinity measures can include simple Euclidean distance or nearest neighbor pairs.

The system obtains data point embeddings either as input or by using an embedding neural network to generate embeddings. Such an embedding neural network takes in the unlabeled training data to generate data point embeddings that have a fixed dimensionality d. For example, an embedding neural network can be trained to generate embeddings that represent affinities between items in the data set. As one example, the embedding neural network can be a Siamese neural network.

The system trains the clustering neural network using the embeddings to optimize the normalized cuts objective (step 306). Generally, the normalized cuts objective includes a first term that measures an expected normalized cuts of clustering nodes in a graph representing the data set into a fixed number of clusters according to clustering outputs generated by the clustering neural network. That is, the normalized cuts objective measures the normalized cuts that would be incurred if the items in a data set were clustered according to the clustering outputs generated by the clustering neural network.

The normalized cuts of clustering a given graph measures, for each cluster in the clustering, a ratio of (i) a total weight of the edges that are removed from the given graph to form a disjoint subgraph of the given graph that includes only the nodes in the cluster to (ii) a total weight of the edges in the given graph that connect to at least one node in the cluster.

When the input data is a data representing an input graph, the weight between two items identifies whether there is an edge between the nodes representing the two items in the input graph, i.e., the weight between two items can be one if there is an edge and zero if there is no edge.

Alternatively, the weights can be affinity weights that are based on distances between the feature embeddings of the items in the subsets in an embedding space.

Affinity weights and training the neural network on this objective will be described in more detail below with reference to FIG. 4.

By training the neural network on this objective, the system can use the trained neural network to generate clustering assignments that have fewer normalized cuts and, therefore, generate high quality cluster assignments even though no labeled data is used during the training.

FIG. 4 is a flow diagram of an example process 400 for training a clustering neural network. For example, a clustering system, e.g., the clustering system 100 of FIG. 2, appropriately programmed in accordance with this specification, can perform the process 400.

The system can repeatedly perform the process 400 for different subsets of items from the training data set to train the clustering neural network by repeatedly adjusting the values of the clustering parameters. By repeatedly performing the process 400, the system can not only train the clustering neural network to accurately cluster the training data but also to generalize to data sets that are not represented in the training data.

The system samples a subset of items from the training data set, i.e., by sampling a batch of size b from the embedding of the items in the training data (step 402).

The system then processes the embedding of each item in the subset using the clustering neural network and in accordance with current values of clustering parameters to determine the assignment probabilities of each item in the subset over g clusters (step 404). That is, the clustering output of the clustering neural network is a respective probability distribution for each of the items in the data set that includes a respective probability for each of the g clusters.

The system then determines affinity weights that measure relationships between each particular item and the other items in the subset (step 406). The system computes the affinity graph by determining the edge weights between adjacent items, or items with an edge between them, for each item in the subset.

In some implementations, the affinity weight identifies whether there is an edge in the input graph between the two nodes in the input graph that represent the two items in the subset.

In some other implementations, the affinity weights are based on distances between embeddings of the items in the subsets in an embedding space. For example, the system can determine the affinity weight from a first item to a second item in the subset based on, e.g., equal to or directly proportional to, the distance, e.g., the L2 norm or other distance measure, between the embedding of the first item and the embedding of the second item. As another example, the affinity weight cane can be based on the distance if the embedding of the second item is within the k nearest neighbors of the embedding of the first item and zero if the embedding of the second item is not within the k nearest neighbors of the embedding of the first item, with k being any fixed integer greater than or equal to one.

The system computes a total affinity weight between each particular item in the subset and all other items in the subset (step 408). For example, the total affinity weight for a particular item can be the total edge weights from that item, i.e., the sum of edge weights for edges between that particular item and other items in the subset.

Based on the affinity weights, total affinity weight, and assignment probabilities, the system determines an update to the current value of the parameters, i.e., by computing a gradient with respect to the clustering parameters of the normalized cuts loss function (step 410).

As described above, the normalized cuts loss function measures an expected normalized cuts of clustering nodes in a graph.

In particular, so that the normalized cuts loss function is differentiable the system can minimize the expected normalized cuts by minimizing the following:

Σ_{reduce-sum}(Y [symbol] Γ)(1−Y)^{T}⊙W,

where (Y [symbol] Γ)(1−Y)^{T}⊙W is a matrix and Σ_{reduce-sum} is the sum over all of its elements. Y is a matrix containing the probabilities that each of the particular items in the subset belongs to a certain cluster, i.e., as generated by the clustering neural network, Γ is a matrix that satisfies Γ=Y^{T} D where D is a column vector that includes the total affinity weights for each of the particular items in the subset, W is a matrix that includes the affinity weights for each of the particular items in the cluster, [symbol] denotes element-wise division, and ⊙ denotes element-wise multiplication.

The system performs iterations of the process 400 until termination criteria for the training are satisfied, e.g., the values of the clustering parameters allow the normalized cuts loss function to converge, or the system has trained for a set amount of time.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining unlabeled training data for training a clustering neural network having a plurality of clustering parameters, wherein:
the training data comprises input data representing a data set of a plurality of items,
the input data comprises a respective feature embedding of each of the plurality of items, and
the clustering neural network is configured to receive the input data and to process the input data in accordance with the clustering parameters to generate, for each item in the data set, a respective clustering output that defines a probability distribution that includes a respective probability for each of a plurality of clusters; and
training the clustering neural network on the unlabeled training data to determine trained values of the clustering parameters by minimizing a normalized cuts loss function that includes a first term that measures an expected normalized cuts of clustering nodes in a graph representing the data set into the plurality of clusters according to clustering outputs generated by the clustering neural network, wherein:
nodes in the input graph represent items in the data set and edges in the input graph represent relationships between items in the data set, and
the normalized cuts of clustering a given graph measures, for each cluster, a ratio of (i) a total weight of the edges that are removed from the given graph to form a disjoint subgraph of the given graph that includes only the nodes in the cluster to (ii) a total weight of the edges in the given graph that connect to at least one node in the cluster.

2. The method of claim 1, wherein the training comprises repeatedly performing the following:
sampling a subset of items from the data set;
processing the feature embedding of each item in the subset using the clustering neural network and in accordance with current values of the clustering parameters to generate a respective probability distribution for each item;
determining, for each particular item in the subset, affinity weights that measure relationships between the particular item and the items in the subset;
determining, for each particular item in the subset, a total affinity weight between the particular item and all other items in the subset; and
determining an update to the current values of the parameters by minimizing the normalized cuts loss function for the subset based on the total affinity weights, the affinity weights, and the probability distributions for the items in the subset.

3. The method of claim 2, wherein the input data is data representing an input graph of nodes and edges, and wherein the affinity weight between two items in the subset identifies whether there is an edge in the input graph between the two nodes in the input graph that represent the two items in the subset.

4. The method of claim 2, wherein the affinity weights are based on distances between the feature embeddings of the items in the subsets in an embedding space.

5. The method of claim 2, wherein determining an update to the current values of the parameters by minimizing the normalized cuts loss function for the subset based on the total affinity weights, the affinity weights, and the probability distributions for the items in the subset comprises:
determining a gradient of a loss function that satisfies:
$$\text{?} ( Y ⌀Γ ) \text{?} ⊙ W ,$$
$$\text{?} \text{indicates text missing or illegible when filed}$$
where (Y [symbol] Γ)(1−Y)^{T}⊙W is a first matrix,
$$\text{?}$$
$$\text{?} \text{indicates text missing or illegible when filed}$$
denotes a sum over the elements of the first matrix, Y is a matrix that includes the probabilities for each of the particular items in the subset, Γ is a matrix that satisfies Γ=Y^{T}D, D is a column vector that includes the total affinity weights for each of the particular items in the subset, and W is a matrix that includes the affinity weights for each of the particular items in the cluster, [symbol] denotes element-wise division, and ⊙ denotes element-wise multiplication.

6. The method of claim 1, wherein obtaining the unlabeled training data comprises:
receiving features of each of the items in the data set; and
processing each of the features using an embedding neural network to generate the feature embeddings for the items in the data set.

7. The method of claim 6, further comprising:
training the embedding neural network to generate feature embeddings that represent affinities between items in the data set.

8. The method of claim 7, wherein the embedding neural network is a Siamese neural network.

9. The method of claim 1, further comprising:
after training the clustering neural network, generating a final clustering of the data set into the plurality of clusters.

10. The method of claim 1, further comprising:
after training the clustering neural network, receiving a new data set and generating a clustering of the new data set without re-training the clustering neural network.

11. The method of claim 1, wherein the training data comprises a plurality of items of visual data.

12. (canceled)

13. One or more non-transitory computer-readable storage media storing instructions that when executed by one or more computers cause the one or more computers to perform operations comprising:
obtaining unlabeled training data for training a clustering neural network having a plurality of clustering parameters, wherein:
the training data comprises input data representing a data set of a plurality of items,
the input data comprises a respective feature embedding of each of the plurality of items, and
the clustering neural network is configured to receive the input data and to process the input data in accordance with the clustering parameters to generate, for each item in the data set, a respective clustering output that defines a probability distribution that includes a respective probability for each of a plurality of clusters; and
training the clustering neural network on the unlabeled training data to determine trained values of the clustering parameters by minimizing a normalized cuts loss function that includes a first term that measures an expected normalized cuts of clustering nodes in a graph representing the data set into the plurality of clusters according to clustering outputs generated by the clustering neural network, wherein:
nodes in the input graph represent items in the data set and edges in the input graph represent relationships between items in the data set, and
the normalized cuts of clustering a given graph measures, for each cluster, a ratio of (i) a total weight of the edges that are removed from the given graph to form a disjoint subgraph of the given graph that includes only the nodes in the cluster to (ii) a total weight of the edges in the given graph that connect to at least one node in the cluster.

14. A system comprising one or more computers and one or more storage devices storing instructions that when executed by the one or more computers cause the one or more computers to perform operations comprising:
obtaining unlabeled training data for training a clustering neural network having a plurality of clustering parameters, wherein:
the training data comprises input data representing a data set of a plurality of items,
the input data comprises a respective feature embedding of each of the plurality of items, and
the clustering neural network is configured to receive the input data and to process the input data in accordance with the clustering parameters to generate, for each item in the data set, a respective clustering output that defines a probability distribution that includes a respective probability for each of a plurality of clusters; and
training the clustering neural network on the unlabeled training data to determine trained values of the clustering parameters by minimizing a normalized cuts loss function that includes a first term that measures an expected normalized cuts of clustering nodes in a graph representing the data set into the plurality of clusters according to clustering outputs generated by the clustering neural network, wherein:
nodes in the input graph represent items in the data set and edges in the input graph represent relationships between items in the data set, and
the normalized cuts of clustering a given graph measures, for each cluster, a ratio of (i) a total weight of the edges that are removed from the given graph to form a disjoint subgraph of the given graph that includes only the nodes in the cluster to (ii) a total weight of the edges in the given graph that connect to at least one node in the cluster.

15. The system of claim 14, wherein the training comprises repeatedly performing the following:
sampling a subset of items from the data set;
processing the feature embedding of each item in the subset using the clustering neural network and in accordance with current values of the clustering parameters to generate a respective probability distribution for each item;
determining, for each particular item in the subset, affinity weights that measure relationships between the particular item and the items in the subset;
determining, for each particular item in the subset, a total affinity weight between the particular item and all other items in the subset; and
determining an update to the current values of the parameters by minimizing the normalized cuts loss function for the subset based on the total affinity weights, the affinity weights, and the probability distributions for the items in the subset.

16. The system of claim 15, wherein the input data is data representing an input graph of nodes and edges, and wherein the affinity weight between two items in the subset identifies whether there is an edge in the input graph between the two nodes in the input graph that represent the two items in the subset.

17. The system of claim 15, wherein the affinity weights are based on distances between the feature embeddings of the items in the subsets in an embedding space.

18. The system of claim 15, wherein determining an update to the current values of the parameters by minimizing the normalized cuts loss function for the subset based on the total affinity weights, the affinity weights, and the probability distributions for the items in the subset comprises:
determining a gradient of a loss function that satisfies:
$$\text{?} ( Y ⌀Γ ) \text{?} ⊙ W ,$$
$$\text{?} \text{indicates text missing or illegible when filed}$$
where (Y [symbol] Γ)(1−Y)^{T}⊙W is a first matrix,
$$\text{?}$$
$$\text{?} \text{indicates text missing or illegible when filed}$$
denotes a sum over the elements of the first matrix, Y is a matrix that includes the probabilities for each of the particular items in the subset, Γ is a matrix that satisfies Γ=Y^{T}D, D is a column vector that includes the total affinity weights for each of the particular items in the subset, and W is a matrix that includes the affinity weights for each of the particular items in the cluster, [symbol] denotes element-wise division, and ⊙ denotes element-wise multiplication.

19. The system of claim 14, wherein obtaining the unlabeled training data comprises:
receiving features of each of the items in the data set; and
processing each of the features using an embedding neural network to generate the feature embeddings for the items in the data set.

20. The system of claim 19, the operations further comprising:
training the embedding neural network to generate feature embeddings that represent affinities between items in the data set.

21. The system of claim 14, the operations further comprising:
after training the clustering neural network, generating a final clustering of the data set into the plurality of clusters.
